(19) United States
(12) Patent Application Publication
(10) Pub. No.: US 2005/0161275 A1
(43) Pub. Date: Jul. 28, 2005

(54) Structure and method for mounting equipment inside vehicles

(76) Inventors: Philippe Serrano, St-Bruno (CA); Danielle Morissette, Varennes (CA); Virgilio Hilario, ST-Hubert (CA); Andre Gagnon, St-Hubert (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 10/762,268

(22) Filed: Jan. 23, 2004

(51) Int. Cl. B60K 1/00

(52) U.S. Cl. 180/291

(57) ABSTRACT

A structure for mounting equipment inside a vehicle. The structure includes at least one structural member defining a platform. The platform is characterized by at least one equipment bay adapted to receive equipment. At least one attachment site is provided on the structural member, where this attachment site is adapted to be resiliently attached to the vehicle such that the platform is suspended inside the vehicle. When the structure is installed inside the vehicle and the vehicle is in motion, the platform is operative to follow the movement of the vehicle while maintaining the equipment mounted thereto in a substantially rigid assembly.

### FIELD OF THE INVENTION

The present invention relates generally to the field of equipment-bearing vehicles. More specifically, the present invention relates to a novel structure and method for mounting equipment inside vehicles. Although the present invention may find particular utility in the context of rail vehicles, such as high-speed trains, and will be described in relation thereto, the invention can also be applied to different types of vehicles, such as tractor-trailers, ships, buses and airborne vehicles, among others.

### BACKGROUND OF THE INVENTION

In existing rail vehicles, such as trains and metros, the railcar body is typically built around a frame, to which are mounted the walls, doors and roof of the railcar body. The frame provides support for people and/or goods being transported within the railcar, as well as for the machinery and equipment operating the vehicle.

In the case of a locomotive railcar, machinery operating the vehicle is provided inside of the railcar, typically mounted directly to the floor of the railcar frame. Such machinery may include a piston engine, a turbine engine, a gearbox, a generator, a high-speed generator, a flywheel, air reservoirs, engine controls and transformers, among many other possibilities.

These rail vehicles travel along rail tracks, which are surfaces that have joints and that are not perfectly level, such that they are a source of vibration for the rail vehicle. Although somewhat filtered by the railcar suspension, some vibrations are nevertheless transmitted to the railcar body, which in turn transfers these vibrations to the machinery installed therein. Accordingly, upon installation of the machinery within the railcar body, many discrete pieces of equipment are typically mounted separately to the frame, using resilient mounts. These resilient mounts act to isolate the equipment from the railcar body, thus reducing vibrations transmitted from the railcar body to the equipment and vice versa, since the machinery may also be a source of vibration. Vibrations transferred from the railcar body to the equipment may adversely affect the equipment, while vibrations transferred from the equipment to the railcar body may generate noise, the railcar body acting as a huge speaker.

When two or more of the discrete pieces of equipment need to be mechanically coupled one to the other, flexible couplings are used to interconnect them, in order to compensate for relative movement therebetween. As is often the case when discrete pieces of equipment are mechanically coupled together, proper alignment between the equipment needs to be maintained at all times in order to ensure good operation of the equipment. This is especially true for certain systems, such as the turbine-gearbox-generator assembly, where the co-axiality of the connected pieces of equipment must be kept to very close tolerances. Unfortunately, the compensation provided by the flexible couplings has proven to be insufficient for meeting these stringent co-axiality tolerances and maintaining the necessary alignment between the various pieces of equipment mounted to the frame. In particular, as a result of the strength of the vibrations transmitted from the track through the railcar frame to the equipment, as well as the deformation of the railcar body under heavy loads, misalignment between cooperating pieces of equipment may lead to equipment failures.

In light of the foregoing, a need clearly exists in the industry for an improved structure and method for mounting equipment inside vehicles, such as rail vehicles.

### SUMMARY OF THE INVENTION

As embodied and broadly described herein, the present invention is directed to a novel structure and method for mounting equipment inside a vehicle.

In a broad aspect, the present invention provides a structure for mounting equipment inside a vehicle, the vehicle having a frame. The structure includes at least one structural member defining a platform, where this platform is characterized by at least one equipment bay adapted to receive equipment. The structure also includes at least one attachment site provided on the structural member. The attachment site is adapted to be resiliently attached to the frame of the vehicle for suspending the platform inside the vehicle. When the structure is installed inside the vehicle, the platform is operative to maintain the equipment mounted thereto in a substantially rigid assembly during motion of the vehicle.

In another broad aspect, the present invention provides a platform assembly for mounting equipment inside a vehicle, the vehicle having a frame. The platform assembly includes at least one structural member defining a platform, where this platform is adapted to receive two or more pieces of equipment. A plurality of attachment sites are provided on the structural member for attaching the platform assembly to the frame of the vehicle, each attachment site being adapted to receive a respective resilient mount. When the platform assembly is installed inside the vehicle, the resilient mounts are operative to isolate the platform from the frame of the vehicle such that the platform floats within the vehicle.

In a specific, non-limiting example of implementation of the present invention, the novel platform assembly is used for mounting equipment inside of a railcar. The platform assembly is formed of a pair of longitudinally extending side members, which define therebetween the platform. A plurality of beam members extend transversely between the side members for delimiting the different equipment bays of the platform. A plurality of attachment sites are provided along each of the side members, for attaching the platform assembly to the frame of the railcar. Each attachment site is adapted to receive at least one rubber mount for supporting the platform, and the equipment mounted thereto, on the frame of the railcar when the platform assembly is installed inside the railcar. The rubber mounts serve to isolate the platform from the frame, since the rubber material is suitable to absorb and dissipate the vibration energy transmitted from the frame of the railcar.

In yet another broad aspect, the present invention provides a method for mounting equipment inside a vehicle, the vehicle having a frame. The method includes the steps of providing a platform adapted to receive a plurality of pieces of equipment, attaching the platform to the frame of the vehicle such that the platform is resiliently suspended within the vehicle, and mounting two or more pieces of equipment to the platform in a substantially rigid assembly.

### BRIEF DESCRIPTION OF THE DRAWINGS

A detailed description of examples of implementation of the present invention is provided hereinbelow with reference to the following drawings, in which:

FIG. 1 is a perspective view of an example of a railcar;

FIG. 2 is side view of the railcar shown in FIG. 1;

FIG. 3 is a front perspective view of a platform assembly for mounting equipment inside the railcar of FIGS. 1 and 2, in accordance with a non-limiting example of implementation of the present invention;

FIGS. 4 to 6 illustrate an example of installation of a turbine-gearbox-alternator assembly onto the platform assembly of FIG. 3; and

FIG. 7 is a front perspective view of a platform assembly for mounting equipment inside the railcar of FIGS. 1 and 2, in accordance with a variant example of implementation of the present invention.

In the drawings, embodiments of the invention are illustrated by way of example. It is to be expressly understood that the description and drawings are only for the purposes of illustration and as an aid to understanding, and are not intended to be a definition of the limits of the invention.

### DETAILED DESCRIPTION

A novel structure and method for mounting equipment inside vehicles is described herein. Although the invention is set forth in relation to rail vehicles, it should be understood that the invention has a wider range of application. In particular, the mounting structure may also be used in magnetically-levitated vehicles, guided transit vehicles, vehicles on tires, ships, buses, trucks, tractor trailers, airborne vehicles (overcrafts), etc.

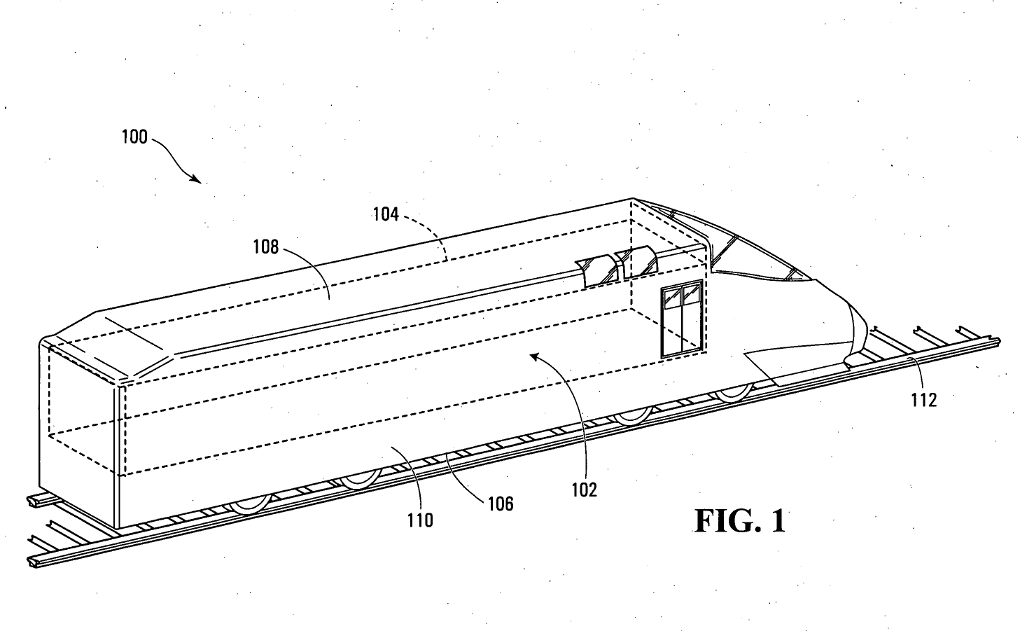

FIG. 1 illustrates an example of a railcar 100, which is provided with a shell 102 built around a frame 104. Although shown in stippled lines, the frame 104 is an assembly of beam members, including transverse beam members extending between the sides of the railcar 100 and longitudinal beam members running the length of the railcar 100. Typically, the shell 102 is closed at the bottom by a floor 106 and at the top by a roof 108, both of which are attached to the longitudinal sides 110 of the shell 102. The frame 104, the floor 106, the roof 108 and the longitudinal sides 110 of the shell 102 act together to support the load of the railcar 100. When in motion, the railcar 100 travels along rails 112.

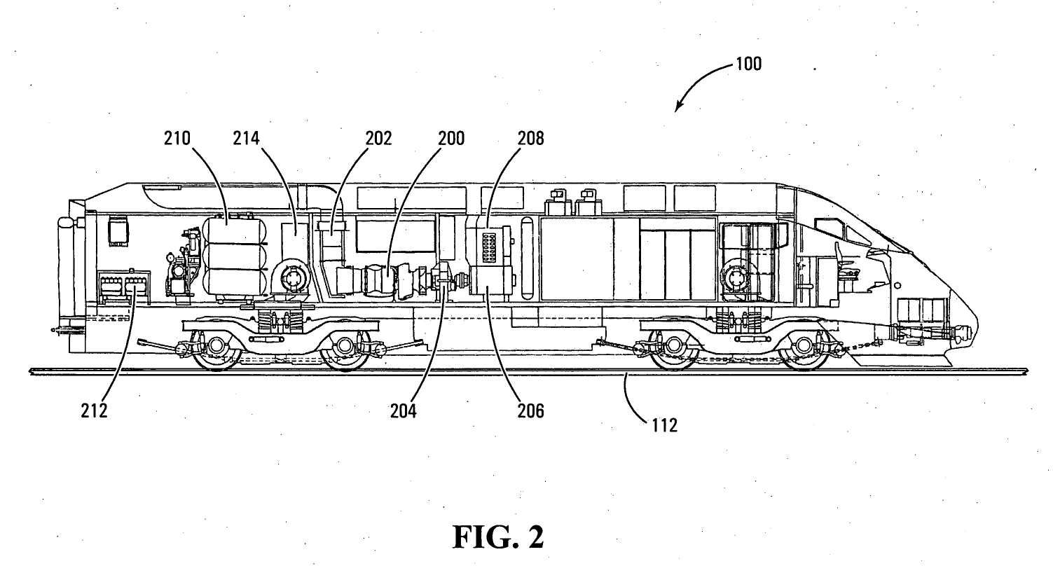

For the purposes of this description, assume that the railcar 100 is a locomotive, such that machinery operating the rail vehicle is provided inside of the railcar 100. As shown in FIG. 2, the locomotive railcar 100 may carry various different pieces of equipment and machinery assemblies, including for example a gas turbine engine 200, a turbine exhaust duct 202, a gearbox 204, alternators 206, an alternator blower 208, air reservoirs 210, batteries 212, turbine power and controls 214, among many other possibilities.

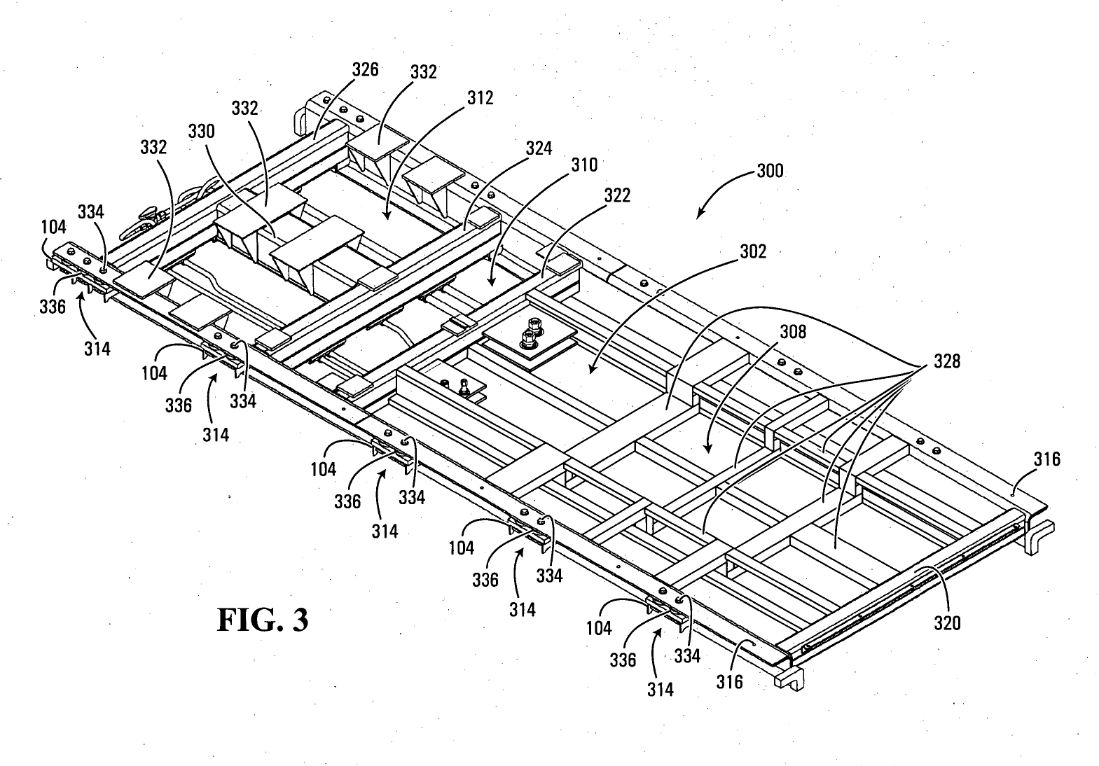

Specific to the present invention, FIG. 3 shows a front perspective view of a structure 300 for mounting equipment inside the railcar 100. The various components of the structure 300 may be made of any suitable material or materials, such as metal, plastic, composite materials, or a combination thereof, among many other possibilities.

The structure 300, also referred to as a platform assembly, includes a platform 302 that is characterized by a plurality of equipment bays 308, 310, 312, where each equipment bay is designated to receive a particular piece of equipment, as will be described in further detail below.

The platform assembly 300 also includes one or more attachment sites 314, which are adapted to be resiliently attached to the railcar 100 such that the platform 302 is suspended within the railcar 100, as will also be described in further detail below. The term “suspended” should be understood as meaning that, when the platform assembly 300 is installed in the railcar 100, the platform 302 floats freely except at the points of contact determined by the attachment sites 314.

In use, the attachment sites 314 of the platform assembly 300 are affixed to the frame 104 of the railcar 100, such that the platform assembly 300 acts as a floor structure, forming at least a part of the floor 106 of the shell 102 of the locomotive railcar 100. Next, various pieces of equipment are mounted to the platform 302, which maintains the equipment mounted thereto in a substantially rigid assembly, even when the railcar 100 is in motion. Alternatively, the equipment may be mounted to the platform 302 before installation of the platform assembly 300 within the railcar 100.

When maintenance to either the platform assembly 300 or the railcar 100 is required, the roof 108 of the railcar 100 may be disassembled and the whole platform assembly 300, including the equipment mounted thereto, may be extracted from the railcar 100 via an opening in the roof 108.

Note that FIG. 3 depicts the platform assembly 300 prior to the installation of any equipment or machinery.

Advantageously, the novel platform assembly is lightweight and thin, such that it can be used to mount equipment in a vehicle in which space is limited and weight affects performance. Furthermore, since the platform is characterized by a rigidity that is independent from the rigidity of the vehicle frame, the stringent co-axiality tolerance requirements of certain equipment assemblies can be met even when the vehicle frame itself deforms during motion of the vehicle. In a specific, non-limiting example of implementation, the platform assembly 300 is composed of a plurality of longitudinal and transversal structural members, which are arranged to form the platform 302 and its equipment bays. These longitudinal and transversal structural members are of different sizes and shapes, in order to accommodate the loads and the mounting points of the various pieces of equipment to be supported on the platform 302. Examples of possible structural members include beams, beam assemblies and support brackets, among other possibilities.

Alternatively, the platform assembly 300 may be composed of a single structural member, such as a skin panel or a sandwich structure formed of upper and lower skins with a core therebetween, that is made of any suitable material(s) and that is shaped to form the platform 302 and its equipment bays. In one example, the platform assembly 300 is composed of a single skin panel made of either a metal or a composite material, where this skin panel may be shaped to provide integral ribs for stiffening the platform assembly 300. In another example, the platform assembly 300 is composed of a single sandwich structure in which the upper and lower skins are made of multi-ply composite material, such as carbon fiber in an epoxy matrix, and the core is made of aluminum honeycomb. In yet another example, the platform assembly 300 is composed of a single sandwich structure in which the upper and lower skins are made of sheets of metal, such as steel, and the core is made of wood.

In the example of implementation shown in FIG. 3, the platform assembly 300 includes a pair of spaced-apart, longitudinally extending, L-shaped side members 316, between which are provided the equipment bays 308, 310, 312 of the platform 302. Although the side members 316 are parallel to one another in the example of FIG. 3, this parallel relationship is not essential; the side members 316 may be positioned such that at different longitudinal positions, the distance between the side members 316 varies.

Note that the equipment bays may hold different types of equipment, such that the size and shape of each equipment bay are determined by the particular piece of equipment to be mounted to the respective equipment bay. Thus, different equipment bays of the platform 302 may be respectively characterized by different sizes and/or shapes.

The platform assembly 300 also includes a plurality of primary beam members 320, 322, 324, 326 extending transversely between the side members 316. These primary beam members serve to delimit and define the different equipment bays 308, 310, 312 of the platform 302.

Each equipment bay 308, 310, 312 is composed of at least one support element, to which is mounted the particular piece of equipment. The support elements of each equipment bay may be of different sizes, shapes and orientations, without departing from the scope of the invention. Furthermore, the support elements may be made of any material suitable for bearing the loads imposed by the respective piece of equipment.

Typically, each primary beam member 320, 322, 324, 326 of the platform assembly 300 acts as a support element for at least one equipment bay of the platform 302.

In the specific, non-limiting example of implementation shown in FIG. 3, the platform 302 is intended to carry the turbine-gearbox-alternator assembly of the rail vehicle, and therefore is provided with three equipment bays 308, 310, 312.

The equipment bay 308 is composed of primary beam members 320 and 322, as well as of a plurality of secondary beam members 328 extending either longitudinally between the primary beam members 320, 322 or transversely between the side members 316. The group of beam members of the equipment bay 308 are adapted to receive the turbine engine 200 and the turbine exhaust duct 202.

The equipment bay 310 is composed solely of the pair of spaced-apart primary beam members 322, 324, which are adapted to receive the gearbox 204.

The equipment bay 312 is composed of the pair of primary beam members 324 and 326, as well as of a secondary beam member 330 extending longitudinally between the primary beam members 324, 326. Support brackets 332 are provided on the longitudinal beam member 330, as well as on the side members 316 within the equipment bay 312, adapted to receive the alternators 206.

Note that, on the platform 302, a particular support element of an equipment bay may simultaneously act as a support element for an adjacent equipment bay. In the example of FIG. 3, primary beam member 322 is a support element for both equipment bay 308 and equipment bay 310, while primary beam member 324 is a support element for both equipment bay 310 and equipment bay 312.

In the non-limiting example of implementation shown in FIG. 3, five attachment sites 314 are located at regular intervals along the underside of each side member 316 of the platform assembly 300. It should be noted however, that any number of attachment sites 314 may be provided on the platform assembly 300, without departing from the scope of the present invention.

The attachment sites 314 are positioned on the side members 316 such as to engage with mating attachment sites provided on the frame 104 of the railcar 100. As such, the attachment sites 314 may be distributed along the underside of the side members 316 according to any one of various different distribution patterns.

Note that the attachment sites 314 may alternatively be provided on the topside or on the side of each side member 316, depending on the particular structural engagement between the side members 316 and the frame 104 of the railcar 100.

Each attachment site 314 includes at least one resilient mount 336, such as a rubber mount, for supporting the platform 302, and the equipment mounted thereto, on the frame 104 of the railcar 100. The resilient mounts 336 are operative to isolate the platform 302 from the frame. 104, since the material of the resilient mounts 336 is suitable to absorb and dissipate the vibration energy transmitted from the frame 104.

Note that different types of resilient mounts may be used, including for example springs and dampers, pneumatic springs, fluid-filled mounts, among others.

Each attachment site 314 also includes one or more mechanical fasteners 334, such as nut and bolt assemblies, for securing the platform 302 to the frame 104 of the railcar 100. Different types of mechanical fasteners may be used without departing from the spirit of the invention.

In the specific example shown in FIG. 3, each mechanical fastener 334 receives a respective rubber mount 336, which is positioned between the side member 316 of the platform 302 and the frame 104 of the railcar 100.

Thus, the points of contact between the platform 302 and the railcar 100 are formed between the side members 316 of the platform assembly 300 and the resilient mounts 336. No direct contact is made between the platform 302 and the frame 104 of the railcar 100, such that the platform 302 floats freely within the railcar 100.

Advantageously, while the suspended platform 302 will itself follow the movement of the railcar 100, the various pieces of equipment mounted to the platform 302, such as the components of the turbine-gearbox-alternator assembly, are maintained in a substantially fixed position relative to one another. In other words, relative movement between the different pieces of equipment mounted to the platform 302, as well as between each piece of equipment and the platform 302, is very limited. The platform assembly 300 thus allows for stringent co-axiality tolerances associated with specific equipment assemblies to be met, regardless of the movement and vibrations transmitted from the frame 104 of the railcar 100 when the rail vehicle is in motion.

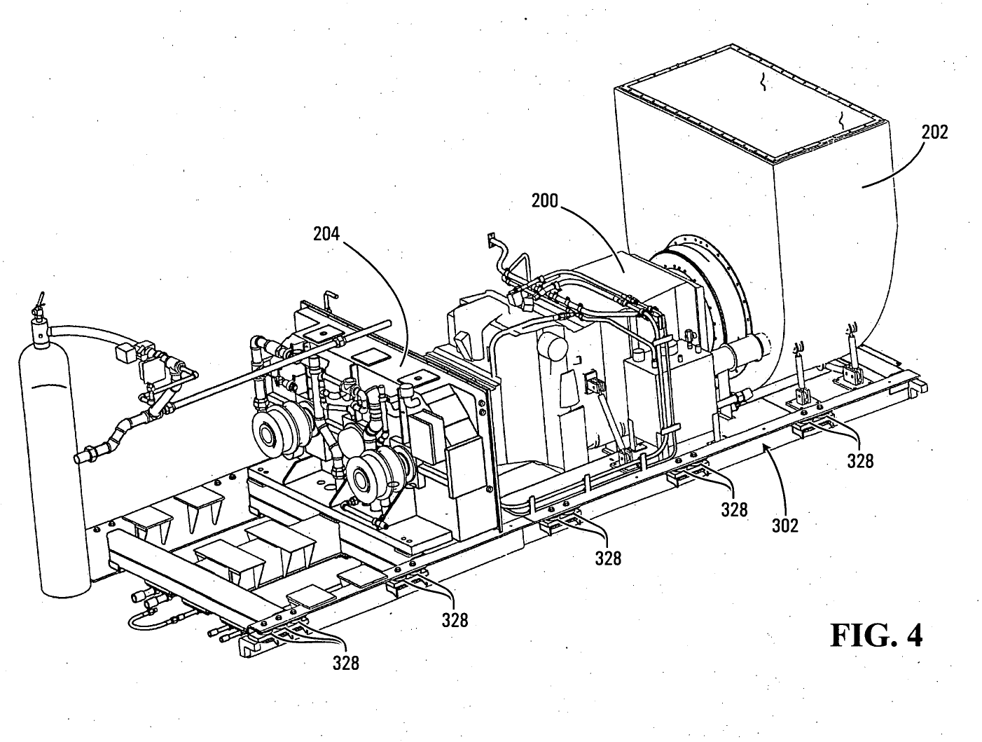

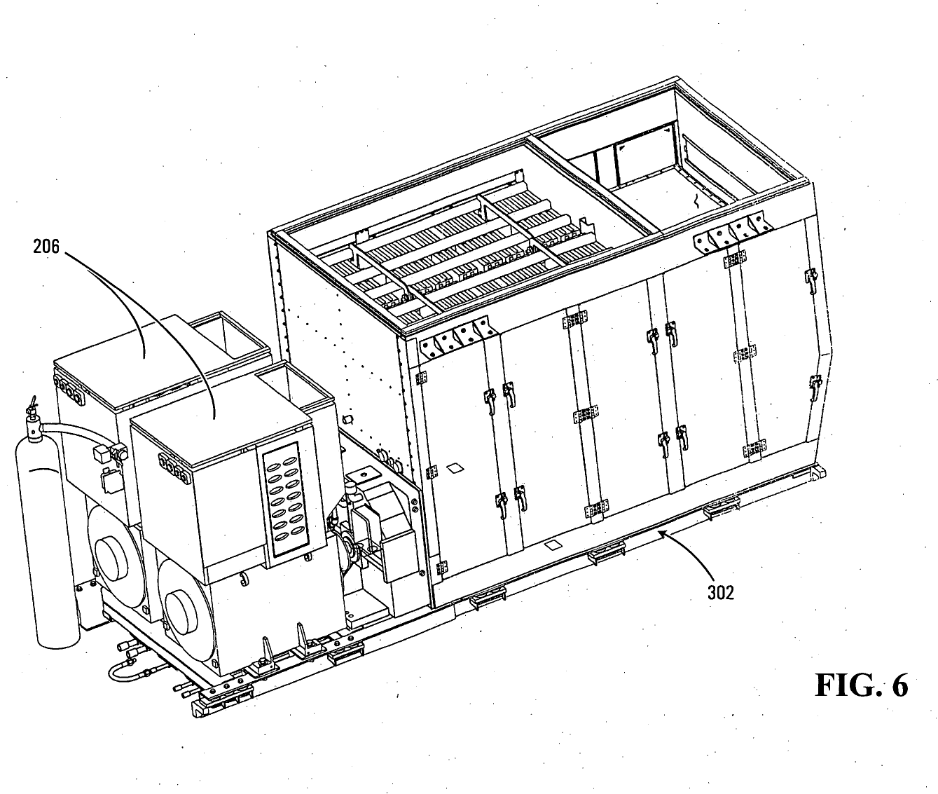

FIGS. 4-6 illustrate an example of installation of the turbine-gearbox-alternator assembly onto the platform 302 of FIG. 3. The various components of the turbine-gearbox-alternator assembly are precisely aligned upon mounting to the platform 302, according to predetermined co-axial specifications, in order to ensure proper operation of the assembly.

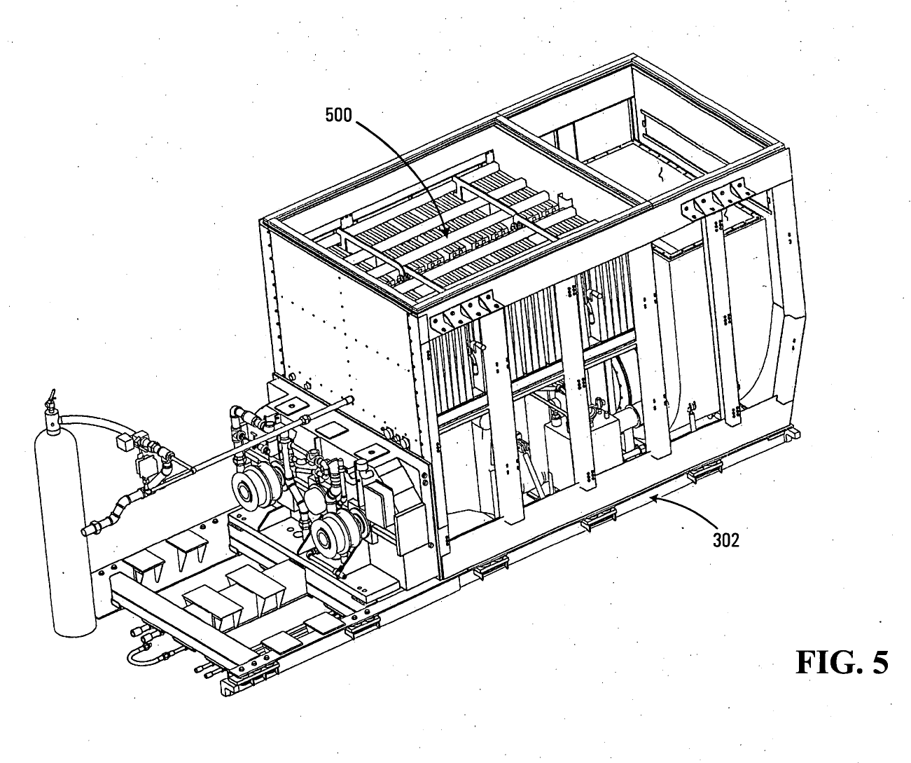

Although not shown in FIG. 5, lateral doors may be provided to close and seal the sides of turbine compartment 500.

It is important to note that the platform assembly 300 is not limited to carrying any particular machinery assembly, nor any particular number of pieces of equipment. As such, the platform 302 may be provided with more or less than three equipment bays, without departing from the scope of the present invention.

The pieces of equipment are removably mounted to the equipment bays using any suitable mechanical fastener(s) or fixture(s). As seen in the example of implementation shown in FIGS. 4-6, possible fasteners may include nuts and bolts, threaded screws, bracket and supporting arm assemblies, among many other possibilities.

In a variant example of implementation, the platform 302 is characterized by a single equipment bay, adapted to receive a plurality of different pieces of equipment, of different sizes and shapes.

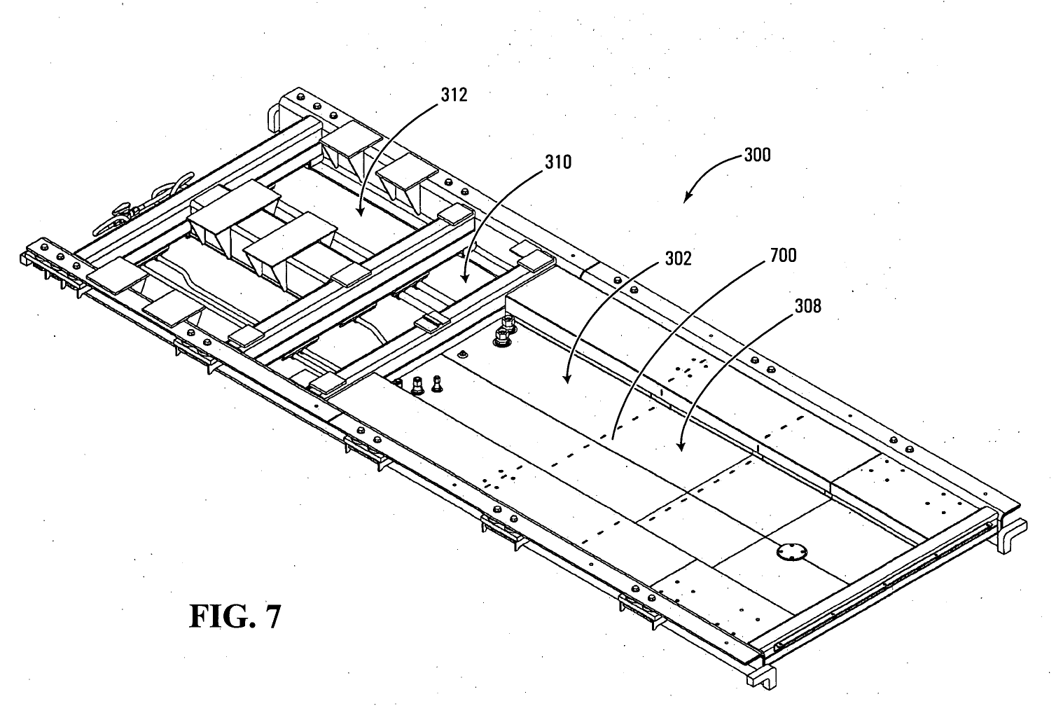

In another variant example of implementation, one or more equipment bays of the platform 302 include a receptacle for collecting fluids that may leak from the equipment mounted to the platform 302. The receptacle forms a floor for one or more of the equipment bays, such that the receptacle is positioned beneath one or more pieces of equipment mounted to the platform 302. In the example shown in FIG. 7, the equipment bay 308 includes a receptacle 700, in the form of an oil pan, that sits on top of the secondary beam members 328 and acts to prevent any eventual oil spillage from reaching the other equipment bays 310, 312. In this particular example, when the turbine compartment 500 is mounted within the equipment bay 308, the receptacle 700 also acts as a seal to prevent air from reaching the turbine engine 200 from anywhere other than the designated air intake. The seal provided by the receptacle 700 may also serve to filter out some of the noise generated within the turbine compartment 500.

In the examples of implementation presented above, the platform assembly 300 has been described in the context of a locomotive railcar 100. However, it should be noted that a platform assembly according to the present invention may be used to carry any type of equipment or machinery, at any location within any type of vehicle.

Although various embodiments have been illustrated, this was for the purpose of describing, but not limiting, the invention. Various modifications will become apparent to those skilled in the art and are within the scope of this invention, which is defined more particularly by the attached claims.

1. A structure for mounting equipment inside a vehicle, the vehicle having a frame, said structure comprising:
at least one structural member defining a platform, said platform being characterized by at least one equipment bay adapted to receive equipment;
at least one attachment site provided on said at least one structural member, said attachment site adapted to be resiliently attached to the frame of the vehicle for suspending said platform inside the vehicle;
wherein, when said structure is installed inside the vehicle, said platform is operative to maintain the equipment mounted thereto in a substantially rigid assembly during motion of the vehicle.

2. A structure as defined in claim 1, wherein said structure includes a plurality of attachment sites provided on said at least one structural member, each attachment site adapted to be resiliently attached to the frame of the vehicle for suspending said platform inside the vehicle.

3. A structure as defined in claim 2, wherein each attachment site is adapted to receive at least one resilient mount, said resilient mount being operative to isolate said platform from the frame of the vehicle when said structure is installed inside the vehicle.

4. A structure as defined in claim 3, wherein said resilient mount is selected from the group consisting of: a rubber mount, a spring, a damper, a pneumatic spring and a fluid-filled mount.

5. A structure as defined in claim 1, wherein said platform is characterized by a plurality of equipment bays, each equipment bay adapted to receive a respective piece of equipment.

6. A structure as defined in claim 5, wherein said structure includes a pair of longitudinally extending structural members defining said platform therebetween.

7. A structure as defined in claim 6, wherein said structure further includes a plurality of beam members extending transversely between said longitudinally extending structural members, said beam members being operative to delimit said equipment bays.

8. A structure as defined in claim 6, wherein at least one attachment site is provided on each of said longitudinally extending structural members.

9. A structure as defined in claim 5, wherein said platform includes a receptacle for collecting fluids, said receptacle being positioned within one or more of said equipment bays such that said receptacle is located beneath one or more pieces of equipment when the one or more pieces of equipment are mounted to said platform.

10. A structure as defined in claim 1, wherein each of the frame of the vehicle and said platform is characterized by a respective rigidity, said structure being operative to ensure that the rigidity of said platform is substantially independent from the rigidity of the frame of the vehicle when said structure is installed inside the vehicle.

11. A structure as defined in claim 1, wherein, when the vehicle is in motion, said platform is operative to maintain a substantially co-axial alignment between two or more pieces of equipment mounted thereto.

12. A structure as defined in claim 1, wherein said structure is a platform assembly.

13. Use of the structure defined in claim 1 for mounting equipment inside a rail vehicle.

14. Use of the structure defined in claim 1 for mounting equipment inside a road vehicle.

15. Use of the structure defined in claim 1 for mounting equipment inside a ship.

16. Use of the structure defined in claim 1 for mounting equipment inside a magnetically-levitated vehicle.

17. Use of the structure defined in claim 1 for mounting equipment inside an airborne vehicle.

18. A platform assembly for mounting equipment inside a vehicle, the vehicle having a frame, said platform assembly comprising:
at least one structural member defining a platform, said platform adapted to receive two or more pieces of equipment;
a plurality of attachment sites provided on said at least one structural member for attaching said platform assembly to the frame of the vehicle, each attachment site adapted to receive a respective resilient mount;
wherein, when said platform assembly is installed inside the vehicle, said resilient mounts are operative to isolate said platform from the frame of the vehicle such that said platform floats within the vehicle.

19. A platform assembly as defined in claim 18, wherein, when said platform assembly is installed inside the vehicle, said platform is operative to maintain the pieces of equipment mounted thereto in a substantially rigid assembly during motion of the vehicle.

20. Use of the platform assembly defined in claim 18 for mounting equipment inside a railcar.

21. A platform assembly for a railcar, the railcar having a frame, said platform assembly comprising:
at least one structural members defining a platform, said platform being characterized by at least one equipment bay adapted to receive equipment;
at least one attachment site provided on said at least one structural member, said attachment site adapted to be resiliently attached to the frame of the railcar for suspending said platform within the railcar;
wherein, when said platform assembly is installed inside the railcar, said platform is operative to maintain the equipment mounted thereto in a substantially rigid assembly during motion of the railcar.

22. A platform assembly as defined in claim 21, wherein said platform assembly includes a plurality of attachment sites provided on said at least one structural member, each attachment site adapted to be resiliently attached to the frame of the railcar for suspending said platform inside the railcar.

23. A platform assembly as defined in claim 22, wherein each attachment site is adapted to receive at least one resilient mount, said resilient mounts being operative to isolate said platform from the frame of the railcar when said platform assembly is installed inside the railcar.

24. A platform assembly as defined in claim 23, wherein, when said platform assembly is installed inside the railcar, said resilient mounts are positioned between said at least one structural member and the frame of the railcar for supporting said platform.

25. A platform assembly as defined in claim 23, wherein said resilient mounts are selected from the group consisting of: a rubber mount, a spring, a damper, a pneumatic spring and a fluid-filled mount.

26. A platform assembly as defined in claim 21, wherein the railcar is a locomotive.

27. A platform assembly as defined in claim 26, wherein the pieces of equipment are selected from the group consisting of: a gas turbine engine, a gearbox, an alternator, a high-speed generator or a flywheel.

28. A method for mounting equipment inside a vehicle, the vehicle having a frame, said method comprising:
providing a platform adapted to receive a plurality of pieces of equipment;
attaching said platform to the frame of the vehicle such that said platform is resiliently suspended within the vehicle;
mounting two or more pieces of equipment to said platform in a substantially rigid assembly.

29. Use of the method defined in claim 28 for mounting equipment inside a railcar.

30. Use of the method defined in claim 28 for mounting equipment inside a road vehicle.

31. Use of the method defined in claim 28 for mounting equipment inside a ship.

32. Use of the method defined in claim 28 for mounting equipment inside a magnetically-levitated vehicle.

33. Use of the method defined in claim 28 for mounting equipment inside an airborne vehicle.
